(19) United States
(12) Patent Application Publication
(10) Pub. No.: US 2019/0392470 A1
(43) Pub. Date: Dec. 26, 2019

(54) Distribution System and Method

(71) Applicants: Jonathan Blanton, Carnegie, PA (US); Marshall James Conover, JR., Presto, PA (US); Sean T. Murphy, Nashville, TN (US)

(72) Inventors: Jonathan Blanton, Carnegie, PA (US); Marshall James Conover, JR., Presto, PA (US); Sean T. Murphy, Nashville, TN (US)

(21) Appl. No.: 16/447,330

(22) Filed: Jun. 20, 2019

Related U.S. Application Data
(60) Provisional application No. 62/687,557, filed on Jun. 20, 2018.

(51) Int. Cl. G06Q 30/02

(52) U.S. Cl. CPC G06Q 30/0215; G06Q 30/0279

(57) ABSTRACT

A service that allows users to: (a) direct distributions of valuable computation services to designated companies, charities or individual recipient parties, (b) allow those recipient parties to retrieve such distributions of valuable computation services; and (c) at the time of providing such valuable computation services, allow system users to identify themselves to the recipient parties or keep themselves anonymous. The results of these valuable computation services may be redeemed as cryptocurrency rewards, service credits, cash payouts and combinations thereof. A related method is also disclosed.

### CROSS REFERENCE TO RELATED APPLICATION(S)

This application is a perfection of U.S. Provisional Ser. No. 62/687,557, filed on Jun. 20, 2018, the disclosure of which is fully incorporated herein.

### BACKGROUND OF THE INVENTION

### 1. Field of the Invention

This invention relates to the field of earned rewards distribution. More particularly, it relates to a new system (and method) for distributing the results of valuable computation services (including crypocurrency mining results) from the parties performing such services to their pre-designated list of reward recipients. This distribution may be performed anonymously or the list of recipients published for all to see. The recipients may be corporations, charities and/or individuals.

### 2. Relevant Art

### Direct Antecedent: Current Pool Donation Logic

Currently, many mining pools allow users to share some percentage of their profits with the pool in order to support the people who run it. This is different in our approach in that it is limited to the pool only, and as such, is not able to be used by service providers, other recipients of donations, etc.

### Anonymous Share Donation

This invention covers an idea in which users who are mining submit individual ‘shares’ of work directly to service providers (specifically Tor providers, who offer a method of internet traffic anonymization), who then forward those shares to mining pools in order to claim the proof of work; in compensation, the service providers offer better service to those users.

This is different from our approach due to requiring the service providers themselves to accept and forward hashes to pools; in addition, the hashes are a complete unit, and cannot be divided.

As such, our service is superior in the sense that in that users could donate ‘lower’ percentages of work than a whole share. In addition, we offer an API services can use to check if users are donating to them, so they don't have to worry about directly working with pools.

### Direct Donation

In addition, multiple efforts have been made at directly donating the profits of mining to a cause or charity. However, our novelty is in allowing users a way to split their donations into percentages, keep some percentage of their gains, and service providers to verify that users have and are donating to them in order to provide services.

### BRIEF SUMMARY OF THE INVENTION

A service that allows users to direct some output of a valuable computational process to companies or individuals, such as Google, the New York Times, or an artist; allows those companies or individuals to retrieve those payments; and, optionally—at the time of the recipient providing a service—allows users to identify themselves to the service provider as a donator/payor to the service, and thus the service can react by fulfilling whatever contract they offer for payments/donations.

The service will provide a user with a tool for performing valuable computations, and a method for managing which entities will receive the proceeds from those computations.

The service will provide a means for service providers to identify a user asking for access to their service, and receive information on whether that user has met the ‘donation’ threshold they have set. The websites can then decide, based on that information, what features/benefits they would give to the user.

The payments of credit for work done could be used, as an example, to exchange cryptocurrency mining time for access to services from companies, such as exchanging cryptocurrency mining computations for use of Google's Gmail service or the NYT website, or simply to donate to people users would like to see produce art/charity/etc. A ‘like-button’—esque widget could be used to donate a set amount of ‘credit’—again using cryptocurrency mining as the example work, perhaps “hashes per second”—or to become a sustaining member of a service. For services, this would be as an alternative or addition to current monetization practices for those services, such as in-application advertising or the allowal of service providers to collect and sell user information.

Importantly, donators will be paying in the form of transferring credit for work done. They will agree to give donation targets credit for some percentage of the work they perform, and when the work is completed, the donation targets will receive rewards from the value-determining entity as if the donation targets had performed the percentage of work themselves.

### BRIEF DESCRIPTION OF THE DRAWINGS

Further features, objectives and advantages of the present invention will be clearer when reviewing the detailed description of preferred embodiments made with reference to the accompanying drawings in which:

FIG. 1 is a flow diagram that illustrates an example interaction between a donator and donation target, noting which where each interaction takes place;

FIG. 2 is a flow diagram that illustrates an example interaction between a donator and service provider, noting which where each interaction takes place;

FIG. 3 is a flow diagram that illustrates the components and users of the system, and the various interactions between them; and

FIG. 4 is a flow diagram that illustrates the workflow undergone in the case of a business user wanting to solve a complex problem such as finite element analysis, and the various stages of that problem being solved and payment being distributed using one embodiment of the system.

### DETAILED DESCRIPTION OF PREFERRED EMBODIMENTS

### Definitions:

As used herein, the following terms shall mean:
CSPT/Donation Configuration—Credit-sharing percentages and targets; i.e., the set of percentages of credit for work done a user will assign to some other individuals or companies, e.g., “5% of credit for my work will be given to the New York Times, 6% to . . . ”.
RoVC/Donation—Results of valuable computations, e.g. cyptocurrency rewards or cash payouts.
PoWRS—An ecosystem made up of daemon-enabled computers, work distribution servers, reward distribution servers, service providers, service requesters, and donation targets.
PoWR (verb)—to configure CSPT to include the direct object, e.g. “The user PoWRS the New York Times with 15% of their mining income”.
Donator—An end user who chooses targets and rates for donations.
Miner—A computer that executes valuable computations on behalf of a donator.
Service provider—An entity which provides a good or service, usually in exchange for RoVC or inclusion in a donator's CSPT.
Pool—a server that distributes computation work to miners and helps validate that the results of those computations fulfill the necessary requirements to be valuable.
Results distribution server—A server which stores, manages, and discloses donation targets, donators, and CSPT data to relevant parties.
Donation target—An entity which receives results of valuable computations which they did not participate in. A donation target is often also a service provider.
Widget—an element of a web page that is provided to service providers by PoWRs to allow users to manage donation configurations or RoVC payouts
   Example of Process using Cryptocurrency Hashrate Percentage Reward and Donation Calculation:

This section will give an example of a user who is performing a valuable computation and then sharing credit for that computational work. It will explain the basic premise of cryptocurrency mining as the example computation being performed, and show how the credit for cryptocurrency mining is shared.

Currently, modern mining pools tend to use a reward-sharing calculation called “pay per last N shares,” or “PPLNS”, in order to give credit to miners for how much work they've performed. The credit given is usually a percent of the work performed by all the miners working together—so, if one person did 5% of the work, they get credited for 5% of it.

In order to explain our system and its modifications to this, the process of ‘hashing’ and PPLNS first must be explained.

### Hashing:

A hash function, as defined on wikipedia, is:
. . . a function which takes an input ‘message’) and returns a fixed-size alphanumeric string. The string is called the ‘hash value’, ‘message digest’, ‘digital fingerprint’, ‘digest’ or ‘checksum’).

The ideal hash function has three ain properties:
1. It is extremely easy to calculate a hash for any given data.
2. It is extremely computationally difficult to calculate an alphanumeric text that has a given hash.
3. It is extremely unlikely that two different messages will have the same hash.

Effectively, some message, for example the word “bar”, is passed into a hashing function, and as a result, the hashing function spits out a noisey return value of an arbitrary size—for example “a542”. Importantly, if that same hashing function is giving “bar” as an input again, it will always spit out “a542” in response.

Small changes in the input—for example, changing “bar” to “bare”—could result in either massive or small changes to the hash functions output. For example, the hash of “bare” could be “0hi4”—an entirely different output from “bar”, despite have only changed one letter.

It is incredibly hard to ‘work backwards’ from a hash value to the input that was given to receive it. In order to figure out that the word “bare” was used to get the hash “Ohi4”, I would effectively have to guess words—e.g., try “apple, cat, clock, bear . . . ” and keep guessing random words until I happened to guess the word “bare” and see it resulted in what I wanted.

### Proof of Work:

The interesting thing about this is that this can be used to prove someone has done work. If I say “find me a word whose hash starts with a 0”, for example, and I allow my hashes to start with the letters “a-z” or the numbers “0-9”, users will have a 1/36 chance of any hash meeting that requirement—since there are 36 characters the hash can start with, and the letter a hash starts with is random.” So, I can know they've done, on average, about 36 guesses once they come back to me with a word whose hash starts with ‘0’.

While workers can get ‘lucky’ at any individual point, for example getting a hash starting with ‘0’ on the first try, when the worker is doing this action repeatedly over long periods of time, the ‘lucky’ and ‘unlucky’ runs will converge to the approximate required guessing—or hashing—rate.

As such, in cryptocurrency ‘mining,’ instructing miners to find hashes with arbitrary difficulties are used by pools (and the cryptocurrency network overall) to prove that some amount of work was done.

### Shares:

The term for a hash that meets a pool's arbitrary difficulty requirements, and can thus be used as a proof of work, is a “share”. Pools set an arbitrary difficulty for their shares based on what makes user activity easy to track without being overwhelming; too easy a difficulty means users are constantly reporting shares, eating up bandwidth—and too hard a difficulty means users very rarely get shares, and as such it's hard to track how much work they're doing.

### Block Payouts:

At the level of a coin, cryptocurrency network mining also consists of setting a difficulty on a hash, and having those miners using the cryptocurrency network trying to find a hash that meets that difficulty. The difficulty is usually targeted towards an amount of time—for example, Bitcoin targets 10 minutes—and is based on the current hashrate of the network. If the network starts finding hashes that match the difficulty every 9 minutes, for example, the bitcoin network will automatically change its difficulty to be slightly harder, in order to move back towards the 10-minute target.

As a reward for finding a hash for the network, the user who finds the hash usually receives a payout of cryptocurrency; on most networks, this payout represents some bulk amount of coin that is newly ‘minted’, in addition to built-in transaction costs the network places upon transactions.

Pools of miners who mine together and receive payouts have to distribute that payout among their users, and in order to maintain membership, have to do so fairly. The dominant current way of doing this is known as “Pay per last N shares.”

### Pay Per Last N Shares Payout Distribution:

Pools who use the “pay per last N shares” (or PPLNS) payout distribution scheme do two things:
1. First, they keep track of their user's submitted shares. So, if a user submits two shares, that fact is recorded in their internal ledger.
2. Second, they only keep the last arbitrary “N” shares sent by all users in-play. So: if they only keep track of the five last shares; a user “Bob” submits two shares; and five more shares are submitted after Bob's then Bob's two shares are “dropped.” The ‘dropping’ mechanic prevents some malevolent behaviors that had appeared in prior payout models.

When a ‘reward’ is received by the pool, users are then paid out based on their percentage of shares in the last N shares before the reward was gained. In the case of a user who mined 2 of the last N shares where N is five, and a reward payout is 10, they would receive ⅖*10=4 coins. A user who found two shares in-between the previous block payout and the latest, but who had their shares ‘dropped’ due to 5 shares having been found since the shares they submitted, would receive nothing.

### An Example of Our New Distribution Model:

In order to further share credit for these computation, our newly-proposed distribution model takes those last N ‘shares’ and multiplies them by some arbitrary amount in order to make them easily distributable by percent. For example, shares could be multiplied by their difficulty, effectively representing them as the number of hashes it statistically would've taken to find them. For our “first character of the hash has to be a ‘0’” example requirement, the difficulty would be 1/36. A user who submitted 5 shares, therefore, would have 180 ‘hashes’ allocated to their account.

The service then would take those 180 hashes and split them according to the donations the user had specified. For example:
If the user had 10% of their overall credit go to an arbitrary service (for example, back to the pool), then that service would receive credit for 18 hashes.
If the user had specified they wanted a flat ‘payment’ of 100 hashes to go to a service, then 100 hashes would be subtracted from their reward and credited to the recipient of the donation.
If the user had no other donations but the above, then they would receive personal credit for the remaining 62 hashes.

The above ordering of transactions is arbitrary; users, the pool, or the service may instead specify that first ‘flat rate’ donations, such as the 100 hashes, are applied, after which percentages are applied. They may also specify a split for each reward—10% goes to flat payouts, the remaining 90% goes to percentage payouts.

In the case the user has more flat-rate donation targets than they can pay out in one reward, a “first-in first-out” system could be used in which payments to the first n services that takes up 100% of their reward is applied. Other systems, such as last-in first-out (new services are preferred over old), round-robin (payouts iterate through at some set rate until the reward or payments are exhausted), or user-prioritization could be used.

The mathematical representation of a percentage-based payout would be:
P=percent of reward being paid to an individual service
S=the sum of hashes for all miners involved in the payout
U_{D}=donation % per user to the service
U_{H}=hashes found per user donating to the service

$$P = \frac{{\sum }_{U \to Users} ( {U}_{D} \times {U}_{H} )}{S}$$

### Additional Initial Service Details:

Our initial service using this invention will use proof-of work mechanisms as described or similar to those above. As such, the parts of the initial service will be:

### Associated Pool:

The service will have an associated cryptocurrency mining pool to start. Users will be able to download an application that automatically mines cryptocurrencies based on instructions from the service. Service providers to whom users are subscribed will be able to specify cryptocurrencies they prefer; the service will, in response, switch those users’ miners to mine towards those cryptocurrency coins for a percentage of time related to their donation percentage for that service.

### Mining Shortcut:

The service will also expose a shortcut for launching a miner; for example, allowing a website to request the user open up a new web page that mines for the pool, or launching a desktop application that mines. This can be achieved by either a website URL, or a browser plugin that launches the correct application.

### Power Widget:

The service will potentially make available a means of one-time donation via a ‘widget’ service-providers can place on their websites that is similar to the concept of a ‘like’ button. This widget could allow users to modify their CSPT in favor of the service provider for some period of time, or donate a set amount of RoVC.

An additional widget could also be provided that users could click to be taken to their service settings in order to access a fuller suite of donation settings for the provider.

Another option that may be available would be embedded links website providers can place on their site that redirects to our service.

### Bulk Transactions:

Internally, in a mining pool, a ledger is kept of how much coin each user ‘owns’ for their work. The mining ‘payouts’ are kept in a singular address on the cryptocurrency network that is owned by the pool. Users can request their coin be sent to a personal address, at which time the amount of coin they own (or some amount of it, based on what amount they request) is split off from this central address and sent to theirs.

A sticking point in this process is that many members of the pool will likely mine very small amounts of cryptocurrency. There is a cost for transactions on most cryptocurrency networks; at current transaction costs for coins such as Bitcoin, Ethereum, or Litecoin, casual users will likely make so small an amount that it would take them, personally, months or years before they've mined enough coin just to overcome the base transaction cost.

Notably, the single cryptocurrency address of the pool provides users the ability to band together with other users to perform a single transaction of coin to a different address. If ten users want to send an amount that, individually, is smaller than the network transaction cost, but in total is more than that cost, then the fact that all of their money is in one address means they can transfer that lump sum in one payment to the address they want to transfer to. This would amortize the transaction cost over all buyers, allowing amounts of coin that would otherwise be “stuck”—had the coin been in seperate addresses—to be transferred to the place users would like it sent to.

As such, our service working with pools will create a new ability for cryptocurrency holders transacting with amounts of cryptocurrency smaller than that cryptocurrencies' network transaction costs to band together with other users in order to overcome that obstacle.

### Payouts:

‘Payouts’ will be based on the representation of the users' submitted Proof-of-work hashes (called POWs from here on) directly as the hashrates that would be required to meet them. For example, a hash found with a difficulty that requires 35,000 hashes would be represented as an added 35,000 hashes to the user's account.

Working with Outside Pools:

The new payment method will be exposed to other pools in that outside pools will be able to contact PoWRs with their PPLNS records—including the users associated with our service who participated in mining that payout—and then ask us what percentage of their payout should be set aside for donation. From there, the outside pools may:
ask our service what percentage of their payouts should be donated, then send us that amount in bulk, with our service then pooling the donated funds from all associated pools and sending them to the correct provider.

In order to create trust between other pools and ours, we may at some time in the future implement a blockchain specifically for the purpose of recording, publicly, what donation percentages service providers will receive from users. Combined with concepts such as tumbling (perhaps using a blockchain technology with tumbling concepts built-in, such as monero), in which user transactions are processed in bulk to make it unclear which address sent money to whom—allowing everyone to know what addresses received which tokens, but not from whom—we would be able to publicly be audited as having sent the correct amount of money to the correct parties without having to reveal each user's individual donation targets.

### Payment Models:

There are several ways that service providers may choose to solicit payouts:
A service provider could request users donate whatever they can. This would likely involve links to the the service site and/or “power widgets” near their content. A user could choose to donate any amount of time or hashes to that service provider, while experiencing no change in content if they elected not to.
A service provider could adopt an account-based payment scheme, or add the service as an alternative to an existing payment scheme. This would allow a SaaS (software as a service) provider such as Netflix to allow users access to their content in exchange for a monthly quota of hashes or mining time.
A service provider could provide additional or alternative services in exchange for a quota of mining time or hashes. For instance, a news site could provide an ad-free experience, or a social network could provide an alternative ToS (terms of service) which opted the user out of the reselling of their data.
A service provider could request a total quota from all users to allow for open access. This “pledge drive” approach would allow large scale miners and small scale miners to work together towards a common cause.
A service provider could specify a desired computational result. This would allow service providers that rely on large amounts of computation power to distribute that computation to their users. For example, Standford's Folding@Home client could run as part of your computation time, or a game developer could provide free access to the game in exchange for running a game server.

### Revenue Models:

There are three valuable resources created by this service: a pooled collection of computation time, a collection of users, and a collection of services that are invested in the payment model. We foresee revenue potential being generated by providing those three resources in the following ways:
Users could donate a portion of their computation time to our company like they would any other service provider.
Companies could pay for use of the payment system, on a per transaction basis (like a credit card), at a flat rate, or scaled proportional to other metrics. So, for example, the New York Times would pay $100 monthly in order to use our services.
Those in need of computational power could pay for access to the network. So, for example, a game developer could pay a flat rate to have their game server as a package that could be run on a user's machine, allowing users to host game matches for that game developer, and receive credit for that hosting which they could then share. This would require a different ‘credit sharing’ mechanism than cryptocurrencies PoW, but would work so long as a mechanism for scoring shares of “work” were creating for it.
Transaction fees could be charged for the service of pooling extremely small transactions.
Extending the service to additional pools as described under “Working with other pools” could be done at the charge of some percentage or fee.

### Derived Revenue Models:

### Containerization and Cloud Platform:

The rise in microservice-based software models, which are those software services based upon the running of many small applications doing one part, with those applications spread across many computers or computer networks, and with those applications being then composed to form larger service frameworks; combined with our ability to provide access to computational resources in the form of users' computers; creates an opportunity for the service to expose a business model based around allowing service providers, such as amazon, to farm out work to users who are renting their computer's time and network access.

The use of ‘containers’ would be an example of how users could do this; effectively, users would download ‘containerized’ applications that do one small part of a larger service's work using the service's desktop application manager, and which exposed a common API to the desktop application manager. The users would then run the containers, which would, as a group, perform arbitrary services that Amazon or Amazon AWS customers would want run.

### Potential Benefits:

Further decentralization over even normal cloud platforms; users could be running containers for a service literally next door to those service's users as opposed to half a continent away, meaning that instead of Amazon or other providers needing to build large datacenters in many places, they will “organically” distribute their resources over geographical areas of use.
Distribution of resource usage; in addition to better response times across the world, the distribution of containers across geographical areas will mean smaller, less-intensive server farms are needed for large cloud platform providers. Fewer centralized servers means less in costs such as air conditioning, which are a significant-enough cost to some companies such that the centers will be moved towards geographical areas which are cooler year-round.

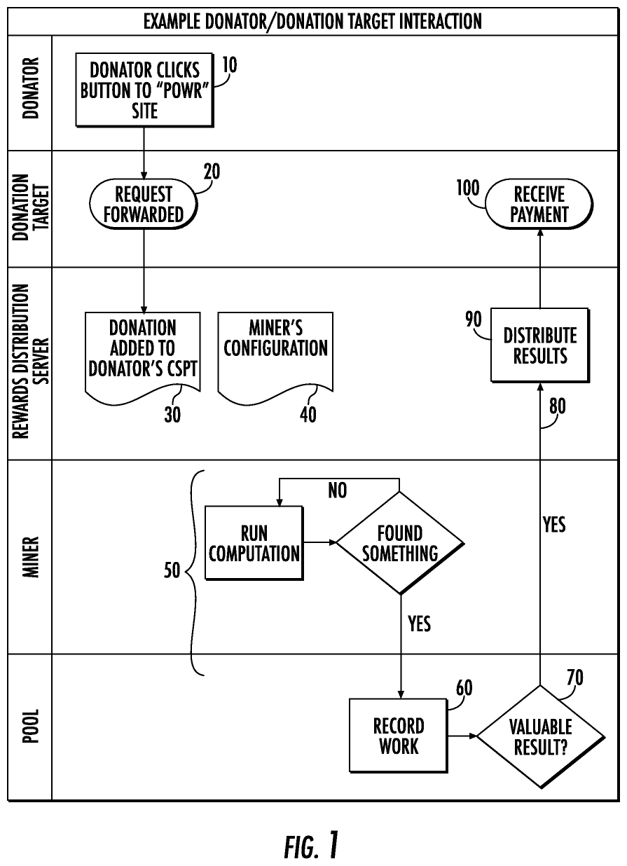

Referring to the accompanying drawings FIG. 1 shows a Donator who when visiting the site of a potential donation target chooses to pledge CSPT to that donation target. That Donator then clicks a button, first Donator button 10, embedded into the donation target's page. That, in turn, forwards the request to the rewards' distribution server, oval 20. Upon receipt of that request, the rewards distribution server modifies the donator's CSPT, action item 30, to reflect the new donation target. Miners running on behalf of that donator pull the latest configuration, item 40, to note any possible changes in targeted computations (such as a different cryptocurrency, or calculation). When the miners next participate in fruitful work, flow loop 50, the pool records the work 60 and sends the valuable result or RoVC from that work (item 70) along with the informad on that the donator contributed to it to the rewards distribution server per line item 80. The rewards distribution server notes that the aforementioned donation target is in the donator's CSPT, and sends (or distributes, item 90) some portion of those RoVC for eventual payment 100 to that donation target.

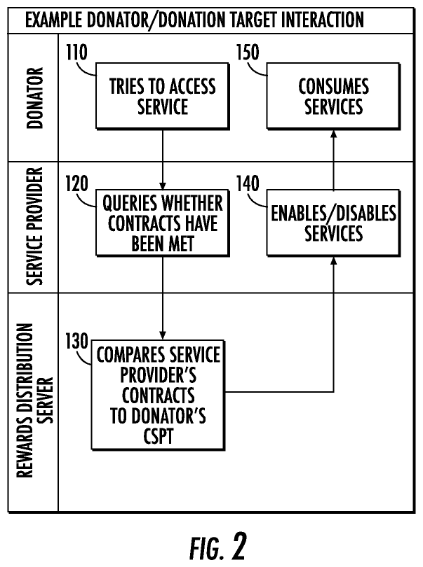

In FIG. 2, a Donator, visiting the site of a service provider, requests access 110 to a set of services. The service provider queries the rewards distribution server 120 with an anonymized identity of the donator to the rewards distribution server. The rewards distribution server compares the set of contracts 130 the service provider has defined with CSPT of the donator, and returns a list of the enabled or disabled service provider contracts 140 donator has met to the service provider. The service provider then provides some consumer services 150 to the donator on the basis of those contracts.

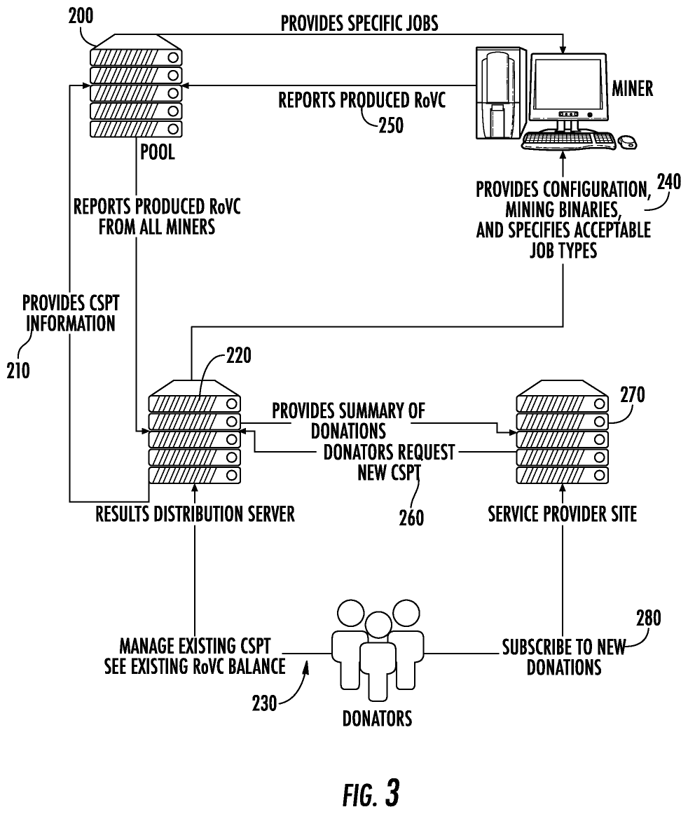

FIG. 3 shows a pool 200 that breaks up large jobs, and provides instructions (and other CSPT information 210) for work to the individual miners. As miners complete jobs, they validate that work and provide information about completed work to the rewards (or results) distribution server 220. When a share of RoVC earned by miners (line 230) has been pledged to donation targets, the pool sends that share to rewards distribution server 220.

The miners execute small jobs, and report work completed for those jobs back to the mining pool for validation. The rewards distribution server 220 provides configuration information and mining binaries to the miners 240. It calculates and reports 250 what percentage of RoVC reported by the pool is pledged to donation targets. It receives RoVC pledged to donation targets from the pool, and distributes it to said targets. It stores and manages donators' CSPT. It compares donators' CSPT 260 to service providers' contracts per item 270.

The donation targets will forward requests for CSPT changes made by donators to the rewards distribution server. Donators will request additions 280 to their donation targets on donation target sites. They will also modify existing CSPT for existing targets on the reward distribution server 220.

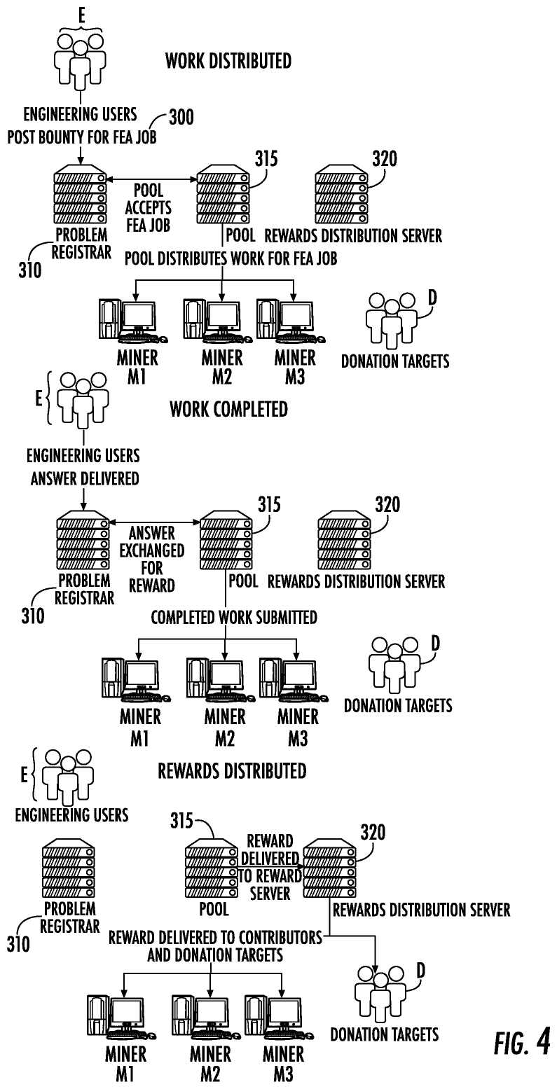

Finally, FIG. 4 shows a business that needs a complex calculation executed. In this case, engineers E need a finite element analysis 300 calculation completed. The business posts a reward for the result of that calculation on a problem registrar 310. The problem registrar is queried by the mining pool 315 which reserves that job, divides it, and distributes its components to miners M1, M2, M3 as they become available.

As each miner completes its subset of the problem, it reports that work back to the mining pool 315. When mining pool 315 has the full solution, it returns that solution to the problem registrar 310 in exchange for the registered payment. The problem registrar 310 in turn returns that solution to the engineers E.

The mining pool 315 delivers some portion of the reward to the rewards distribution server 320. The rewards distribution server 320 calculates the percentage of the reward that is delivered to various miners, and the percentage promised to various donation targets D on the basis of the CSPT of the miners' affiliated donors. Rewards are distributed to participating donors and donation targets D.

Having described the presently preferred embodiments, it is to be understood that this invention may otherwise be covered by the scope of the claims that follow.

What is claimed is:

1. A system for distributing results of valuable computation services performed by one or more parties to multiple recipient parties regardless of whether any of said multiple recipient parties performed any of said valuable computation services after said results of valuable computation services have been completed, said system comprising:
(a) for each system user, a set of distribution functions, said set of distribution functions including: a first list of recipient parties to receive results of valuable computation services, time spent by one or more parties performing such valuable computation services, and total number of valuable computation services performed, said set of distribution functions determining how all results of valuable computation services performed by that system user will be distributed;
(b) means for adding or subtracting receipient parties from the first list for each system user;
(c) means for changing one or more of the set of distribution functions on the first list for each system user; and
(d) one or more computers for performing the valuable computation services and earning results of valuable compensation services for eventually distributing per the first list for each system user, and any recipient party additions or subtractions from the first list and any changes to the set of distribution functions to the first list for each system user.

2. The system of claim 1 wherein the results of valuable computation services are selected from the group consisting of cryptocurrency rewards, service credits, cash payouts and combinations thereof.

3. The system of claim 1 wherein the results of valuable computation services include non-currency distributable computations of indeterminate value that may be fully or partially exchanged for currency.

4. The system of claim 1 wherein each system user may elect to publish their own first list of recipient parties.

5. The system of claim 1 wherein the results of valuable computation services distribution can be independently audited against one or more of the system users' set of distribution functions.

6. The system of claim 1 wherein one or more of the receipient parties is a charitable entity.

7. The system of claim 1 wherein one or more of the recipient parties is a corporate entity.

8. The system of claim 1 wherein at least one of the system users are kept anonymous to one or more of the recipient parties.

9. The system of claim 1, which further includes:
(e) means for validating when a full or partial distribution of results of valuable computation services to one or more of the recipient parties has been completed.

10. The system of claim 1, which further includes:
(i) one or more contracts between system users and recipient parties who are designated to receive results of valuable computation services from the system, said one or more contracts defining terms by which results of valuable computation services will be exchanged between the one or more parties performing such valuable computation services and the first list of recipient parties receiving such results of valuable computation services under the system; and
(ii) means for each system user and each of the recipient parties to validate whether said contract terms have been satisfactorily fulfilled.

11. The system of claim 10 wherein such contract services include free or reduced advertising.

12. The system of claim 10, which further includes:
(a) means for prioritizing some forms of work over others; and
(b) adjusting service prices based on such forms of work prioritizing.

13. A system for distributing results of crypocurrency mining services performed by one or more parties to multiple recipient parties regardless of whether any of said multiple recipient parties performed any of said crypocurrency mining services after said results of crypocurrency mining services have been earned, said system comprising:
(a) for each system user, a set of distribution functions, said set of distribution functions including: a first list of recipient parties to receive results of crypocurrency mining services, time spent by one or more parties performing such crypocurrency mining services, and total number of crypocurrency mining services performed, said set of distribution functions determining how all results of crypocurrency mining services performed by that system user will be distributed;
(b) means for adding or subtracting receipient parties from the first list for each system user;
(c) means for changing one or more of the set of distribution functions on the first list for each system user; and
(d) one or more computers for performing the crypocurrency mining services and earning results of crypocurrency mining services for eventually distributing per the first list for each system user, and any recipient party additions or subtractions from the first list and any changes to the set of distribution functions to the first list for each system user.

14. The system of claim 13 wherein the results of crypocurrency mining services are selected from the group consisting of cryptocurrency rewards, service credits, cash payouts and combinations thereof.

15. The system of claim 13 wherein each system user may elect to publish their own first list of recipient parties.

16. The system of claim 13 wherein the results of valuable computation services distribution can be independently audited against one or more of the system users' set of distribution functions.

17. The system of claim 13 wherein one or more of the receipient parties may be kept anonymous or published, said list of recipient parties being selected from the group consisting of a charitable entity, a corporate entity, an individual and combinations thereof

18. A method for distributing results of crypocurrency mining services performed by one or more parties to multiple recipient parties regardless of whether any of said multiple recipient parties performed any of said crypocurrency mining services after said results of crypocurrency mining services have been earned, said method comprising:
(a) providing a system that comprises:
(i) for each system user, a set of distribution functions, said set of distribution functions including: a first list of recipient parties to receive results of crypocurrency mining services, time spent by one or more parties performing such crypocurrency mining services, and total number of crypocurrency mining services performed, said set of distribution functions determining how all results of crypocurrency mining services performed by that system user will be distributed;
(ii) means for adding or subtracting receipient parties from the first list for each system user;
(iii) means for changing one or more of the set of distribution functions on the first list for each system user; and
(iv) one or more computers for performing the crypocurrency mining services and earning results of crypocurrency mining services for eventually distributing per the first list for each system user, and any recipient party additions or subtractions from the first list and any changes to the set of distribution functions to the first list for each system user;
(b) allowing each system user to providing their first list of recipient parties, either anonymously or published at a preferred location;
(c) allowing the crypocurrency mining services to be performed on one or more computers so as to earn said results of crypocurrency mining services for distribution according to each system user's first list of recipient parties; and
(d) validating when a full or partial distribution of results of crypocurrency mining services to one or more of the recipient parties has been completed.

19. The method of claim 18, which further includes:
(e) independently auditing when the results of crypocurrency mining services have been distributed be against one or more of the system users' set of distribution functions.
